(19) United States
(12) Patent Application Publication
(10) Pub. No.: US 2026/0032461 A1
(43) Pub. Date: Jan. 29, 2026

(54) AFFINITY BASED PLACEMENT OF RADIO UNITS IN DISTRIBUTED UNIT POOLS FOR RADIO ACCESS NETWORK (RAN) WIRELESS SYSTEMS

(71) Applicant: DISH Wireless L.L.C., Englewood, CO (US)

(72) Inventor: Michael Tarver, Allen, TX (US)

(73) Assignee: DISH Wireless L.L.C., Englewood, CO (US)

(21) Appl. No.: 18/780,781

(22) Filed: Jul. 23, 2024

(51) Int. Cl. H04W 24/02; H04W 88/08

(52) U.S. Cl. CPC H04W 24/02; H04W 88/085

(57) ABSTRACT

Systems, devices and automated processes automatically and intelligently assign radio units (RUs) to distributed units (DUs) available within a virtualized pool in an Open RAN network. RUs can be intelligently paired with an available DU using an affinity and/or anti-affinity rule set, if desired. RUs can be assigned to create or to avoid geographic and/or spectrum overlap, thereby minimizing potential outage areas during maintenance periods, reducing interference, improving network coverage and/or any number of other purposes. Automatic assignment of RUs to DUs can be performed by control logic at a data center or elsewhere within the network and may be repeated as needed to support changing conditions and/or as otherwise needed to improve the robustness and flexibility of the Open RAN network.

### TECHNICAL FIELD

The following generally relates to wireless data networks, such as radio access network (RAN) based wireless networks. More particularly, the following relates to systems, devices and automated processes to automatically place radio units (RUs) into pools of distributed units (DUs) for use in Open RAN networks and the like.

### BACKGROUND

Wireless networks that transport digital data and telephone calls are becoming increasingly sophisticated. Currently, fifth generation (“5G”) and even sixth generation (“6G”) broadband cellular networks are being designed and deployed around the world. These advanced networks use emerging technologies to support data and voice communications with millions, if not billions, of mobile phones, computers and other devices. Advanced technologies are capable of supplying much greater bandwidth than was previously available, so it is likely that the widespread deployment of these new mobile networks could radically expand the number of services available to customers.

Traditionally, data and telephone networks relied upon proprietary designs, specialized hardware and dedicated point-to-point data connections. More recently, industry standards such as the Open Radio Access Network (“Open RAN” or “O-RAN”) standard have been developed to describe interactions between the network and various client devices. The O-RAN model follows a virtualized wireless architecture in which wireless base stations (“gNBs”) are implemented using separate centralized units (CUs), distributed units (DUs) and radio units (RUs), along with various control planes that provide additional network services and functions.

Generally speaking, the RUs provide wireless communications in a particular geographic area, so it is necessary for the RU to incorporate one or more physical transmitters, antennas and other hardware that is physically located onsite within broadcast range of the end user's device. Appropriate numbers of RUs are deployed across the geographic area to be covered by the network. Traditionally, each radio unit would be located at a tower or similar broadcast location that has access to on-site radio equipment control (REC) hardware that controls the radio communications at that location. The radio and the REC typically communicate via a “front haul” connection that spans a relatively short distance (e.g., on the order of ten meters or so), often implemented with a conventional or enhanced Common Public Radio Interface (CPRI) interface over a coaxial cable or the like.

More recently, Open RAN concepts have allowed RUs to be implemented at relatively “dark” locations that may not provide on-site access to REC hardware. For these dark locations, a fiber optic, Ethernet or similarly high-bandwidth front haul connection can connect the RU to a DU that is located remotely (e.g., in a data center) across a distance of 20 km or more. The use of “dark” sites greatly expands the flexibility of the network by permitting access to new sites (e.g., tall buildings) that lack REC hardware and that may not have been specially constructed for use as a cellular site, but that nevertheless provide convenient and efficient transmission points for the network.

Removing DU processing from the radio site can also facilitate very efficient distribution of certain network functions to cloud-based computing resources, such as those available from Amazon Web Services (AWS) or others. Cloud-based processing can provide much better network management, scalability, reliability and redundancy, as well as other benefits. To that end, O-RAN CUs, DUs, control planes and/or other components of the network can now be implemented as software modules executed by distributed (e.g., “cloud”) computing hardware. Other network functions such as access control, message routing, security, billing and the like can similarly be implemented using centralized cloud computing resources. Often, a CU, DU, control plane or other image is created in software for execution by one or more virtual computers operating in parallel within the cloud environment. The many virtual servers can be very rapidly scaled to increase or decrease the available computing capacity as needed, often in real time.

The use of virtualized hardware provides numerous benefits in terms of rapid deployment and scalability, but it also presents certain technical challenges that have not been encountered in more traditional wireless networks. Unlike previous wireless networks that scaled through the addition of physical routers, switches and other hardware, RAN networks can scale upwardly and downwardly very quickly as new cloud-based services are deployed and/or existing services are retired or redeployed. Additional network components can be very quickly deployed, for example, through the use of virtual components executing in a cloud environment that can be duplicated and spawned as needed to support increased demand. Similarly, virtual components can be de-commissioned very quickly with little cost or effort when network capacity allows. The virtual components provide substantial efficiencies, especially when compared to prior networks that were based upon complex interconnections between geographically dispersed routers, servers and other physical hardware. The flexibility afforded by virtual processing and longer front haul connections, however, can present new technological challenges that are not present in more traditional networks.

In particular, challenges can arise in maintaining effective interconnection between RUs and DUs that reside within a pool of available DUs within in a data center, cloud environment or the like. In particular, it can be a challenge to create RU-DU pairings that limit exposure to outages, planned downtime and/or other events that may occur, and to update these pairings as network conditions evolve over time.

A substantial desire therefore exists to build systems, devices and automated processes that allow for intelligent pairing of radio units to distributed units within Open RAN wireless networks. These and other features are described in increasing detail below.

### BRIEF SUMMARY

According to various embodiments, systems, devices and/or automated processes automatically and intelligently assign radio units to distributed units available within a virtualized pool in an Open RAN network. In some implementations, an affinity and/or anti-affinity rule set can be created to intelligently pair each RU with an available DU. RUs can be assigned to create or avoid geographic and/or spectrum overlap, for example. Other embodiments can be configured to minimize potential outage areas during maintenance periods, and/or for any other purposes. Automatic assignment of RUs to DUs can be performed by control logic at a data center or elsewhere within the network and may be repeated as needed to support changing conditions and/or as otherwise needed to improve the robustness and flexibility of the Open RAN network.

In one example embodiment, a wireless network system is implemented using a data processing cloud. The wireless network system suitably comprises: a plurality of Open Radio Access Network (RAN) radio units (RUs), each of the plurality of RUs each having an associated geographic location; a pool of RAN distributed units (DUs) associated with a data processing system, the data processing system comprising a plurality of DU processors each executing one or more of the pool of RAN DUS; and a controller associated with the data processing system, wherein the controller is configured to automatically assign each of the plurality of RUs to one of the DU processors available in the pool based upon the geographic location associated with the RU to thereby prevent RUs in geographical proximity to each other from being assigned to the same DU processor.

In another example, a computer system to automatically assign RAN RUs to DUs operating within a pool of available DUs suitably comprises a plurality of DU processors each configured to perform the functions of one or more of the RAN DUs in the pool, and a controller configured to automatically assign each of a plurality of RAN radio units (RUS) to one of the DU processors based upon a geographic location associated with the RU and thereby prevent RUs in geographical proximity to each other from being assigned to the same DU processor in the pool of DU processors. The DU processors may be implemented using physical hardware (e.g., rack mounted computers residing within a data center or the like), and/or with virtual computing resources available from a cloud processing service. Virtual DU processors may be implemented with virtual private cloud (VPC) resources, with worker node structures implemented within a Kubernetes container system or the like, and/or in any other manner desired.

In another example, an automated process is performed by a physical or cloud-based computer system to automatically assign each of a plurality of Open Radio Access Network (RAN) radio units (RUs) to available RAN distributed units (DUs) within a pool of DU processors. The automated process suitably comprises: obtaining, by the computer system, a geographic attribute of each RU; determining, by the computer system for each of a plurality of candidate DUs within the pool of DU processors based upon the geographic attribute of the RU, whether the RU is in geographical proximity to other RUs assigned to the same DU processor; and assigning the RU to the same DU processor if the geographical proximity to other RUs complies with a geographic affinity rule, and otherwise evaluating another of the plurality of candidate DUs.

Various additional embodiments provide other systems, devices and/or automated processes to automatically and intelligently assign RAN RUs to RAN DUs that are available within a virtualized pool in an Open RAN network. These and other example embodiments are described in increasing detail below.

### DRAWING FIGURES

FIG. 1 shows an example of a wireless network including a virtualized pool of distributed units allocated based upon affinity concepts.

FIG. 2 is a flowchart illustrating an example of a process for assigning RUs to appropriate DUs within a virtualized pool in a RAN network.

### DETAILED DESCRIPTION

The following detailed description is intended to provide several examples that will illustrate the broader concepts that are set forth herein, but it is not intended to limit the invention or the application and uses of the invention. Furthermore, there is no intention to be bound by any theory presented in the preceding background or the following detailed description.

Open RAN radio units (RUs) can be automatically assigned to distributed units (DUs) using concepts related to affinity (e.g., keeping RUs together on a DU service) or anti-affinity (e.g., spreading DUs across different DU services), as desired. RUs may be automatically assigned to reduce the effects of outages in a geographic area, to create or avoid spectrum overlap (e.g., to create redundancy and/or to reduce interference) and/or for any other purpose. In many cases, RUs are dynamically assigned to available DUs by control logic residing within a data center or cloud-based processing plane, and assignments may be updated on any regular or irregular basis.

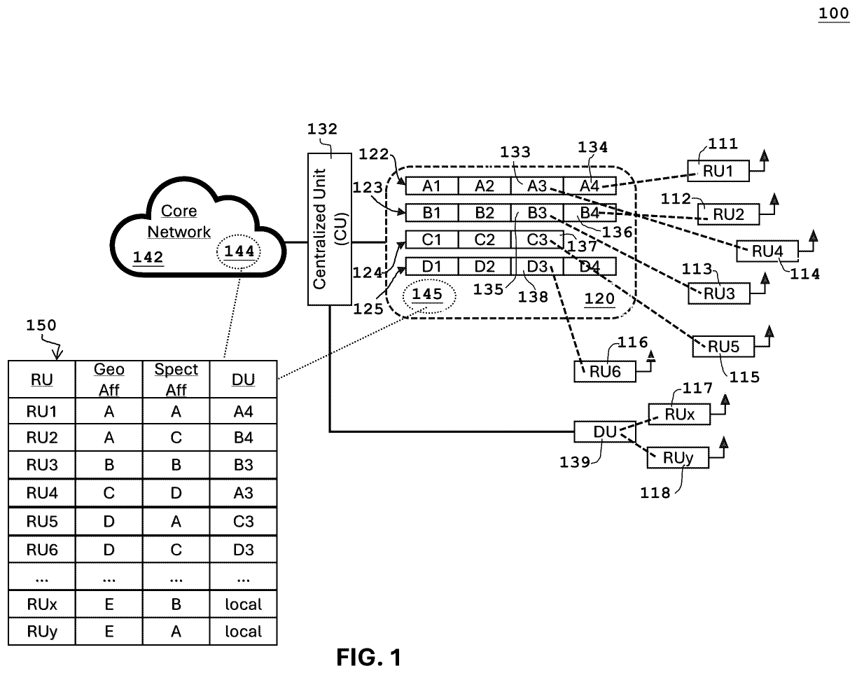

With reference to the drawings and initial reference to FIG. 1, an example Open RAN wireless network system 100 suitably includes any number of O-RAN RUs 111, 112, 113, 114, 115, 116, 117, 118 that communicate with one or more O-RAN DUS 133, 134, 135, 136, 137, 138 and/or 139. In the example illustrated in FIG. 1, DU 139 is shown in communication with two RUs 117, 118, as may be present at a “lit” site wherein the DU 139 is geographically located within a few meters or so of RUs 117, 118. FIG. 1 also illustrates a data center 120 including any number of server systems 122, 123, 124, 125 that are capable of supporting one or more DUs in a shared location. Each of the DUs 133-139 communicates with an O-RAN centralized unit (CU) 132 that manages communications with control planes or other network services existing within a core network 142 executing within a data processing cloud. Typically, RU-DU assignment is automatically processed by control logic 144 and/or 145 residing within the core network 142 and/or data center 120, respectively. Other embodiments could use other processing resources, if desired, such as any other server(s) residing in any physical or virtual location. Still other embodiments could distribute the RU-DU assignment process amongst one or more RUs and/or DUs themselves, if desired.

In many embodiments, each RU 111-118, DU 133-139 and CU 132 is implemented substantially in accordance with Open RAN standards. “Substantially” as used in this context is intended to recognize that some minor variations may be present due to implementation needs, differences in programming styles or languages, timing of new standard versions, and/or other factors without departing from substance of the standards, as may be updated from time to time.

The Open RAN standard breaks communications into three main domains: the radio unit (RU) that handles radio frequency (RF) and lower physical layer functions of the radio protocol stack, including beamforming; the distributed unit (DU) that handles higher physical access layer, media access (MAC) layer and radio link control (RLC) functions; and the centralized unit (CU) that performs higher level functions, including quality of service (QOS) routing and the like. The CU also supports packet data convergence protocol (PDCP), service data adaptation protocol (SDAP) and radio resource controller (RRC) functions, as desired. The RU, DU and CU functions are described in more detail in the Open RAN standards, as updated from time to time, and may be modified to implement the various functions and features described herein.

To that end, each RU 111-118 in FIG. 1 is generally implemented as an Open RAN RU that is located on-site to provide geographic coverage for a portion of wireless network 100. Each RU 111-118 is typically provided with one or more antennas for transmitting and receiving wireless communications with any number of phones or other user equipment (UE) distributed across a geographic area. Generally speaking, it is desirable to place the various RUs at locations within the coverage area to maximize coverage, and to ensure that each UE operating in the area is able to obtain sufficient communications coverage as the UE roams about the area. Often, RUs are assigned portions of available spectrum for wireless communications. The particular portions of spectrum assigned to each RU can be selected based upon affinity (e.g., a desire to provide efficient use of the available spectrum) or anti-affinity (e.g., a desire to prevent adjoining cells from interfering with each other), as appropriate.

User equipment (UEs) refers to mobile phones or other portable devices that can move between different cells associated with the different RUs, although RAN networks are also widely expected to support home and office computing, industrial computing, robotics, Internet-of-Things (IoT), drones, and/or many other devices. UEs access the network 100 via one or more RUs 111-118 that each communicate on a defined portion of RF spectrum. A practical implementation will typically have any number of RUs 111-118 that can each be individually configured to provide highly configurable geographic coverage for the RAN network 100. Each RU 111-118, then, suitably communicates with UEs operating within geographic range using one or more antennas/towers capable of transmitting and receiving wireless messages within the spectrum of electromagnetic bandwidth that is assigned to that RU 111-118.

RUs 111-118 may be physically implemented in any manner. In various embodiments, each RU is implemented using a rack-mounted or other computer or the like that is provided with suitable interfaces to antennas, front-haul communications, and/or the like. As noted above, RUs 117-118 may be physically located near a tower or other “lit” site that also provides an on-site DU 139, as appropriate. On-site DUs 139 may be similarly implemented within a computer system having a processor, memory and interfaces to the front haul and mid-haul connections.

RUs 111-116 could be equivalently located in “dark” sites that may not have on-site DU processing. In such cases, each RU 111-116 is provided with access to a front haul connection to a data center 120 and/or processing cloud 132 as desired. These longer distance front haul connections could be, for example, IEEE 802.11 (“Ethernet”) connections, fiber optic connections, and/or the like. Different types of front haul connections may be freely inter-mixed within a practical network 100, as desired.

In the example of FIG. 1, a breakout edge data center (BEDCs) 120 may be provided to support a geographic local zone (LZ) supporting any number of RUs 111-118 with any number of DUs 133-138, as described more fully herein. The BEDCs are ideally organized for very low latency to provide the best possible throughput and low latency to the various UEs operating within the local zone of network 100. Although FIG. 1 illustrates CU 132 as being outside of data center 120, equivalent embodiments of BEDC 120 could implement one or more CUs 132 within the data center 120 in accordance with the O-RAN specifications. BEDC 120 may also implement user plane functions that handle user data sessions for gaming, streaming and other network services, if desired.

The example illustrated in FIG. 1 shows data center 120 as providing four racks 122, 123, 124, 125 each supporting one or more computer systems capable of hosting any number of DUs 133-138, as appropriate. Rack 122, for example, would typically include one or more computer systems each with one or more processors and non-transitory digital storage (e.g., magnetic or solid state data storage). Each computer system will also include appropriate hardware and/or software interfaces to communicate with control logic 144 and/or 145, as well as with any appropriate RUs 111-118 and/or other nodes as desired.

Some or all of the DUs and/or CUs within network 100 could be equivalently hosted using virtualized hardware provided by AWS or another cloud computing service. DUs 133-138 and/or CU 132 could be implemented using virtual private clouds (VPCs), for example. Equivalently, some of all of the DUs 133-138 and/or CU 132 could be implemented within container structures, such as worker nodes that are managed by control logic 144 and/or 145 acting as a control plane or the like. Worker nodes could be used to implement DUs 133-138 and/or CU 132 with any combination of physical hardware, virtual hardware and/or nodes in a cloud service, as desired. One example of a system that provides container management with worker nodes operating under the direction of a control plane is the KUBERNETES system developed by Google Inc. and maintained by the Cloud Native Computing Foundation of San Francisco, California, although other container management systems could be used in other embodiments. Again, any number of BEDCs or other data centers 120 may be equivalently implemented using any number of physical computers and/or shared VPCs and other virtual computing structures executing in a cloud environment.

In the example of FIG. 1, CU 132 is illustrated to logically reside between BEDC 120 and network 142. One or more CUs 132 could be equivalently implemented within BEDC on a physical or virtual computer system, or outside of BEDC 120 in a virtualized space, if desired. CUs 132 could be implemented within a computing cloud along with core network 142, for example. In either case, CU 132 is implemented with a physical or virtual processor and non-transitory storage executing programmed instructions substantially in accordance with Open RAN standards, as may be updated from time to time, and as further described herein.

As shown in FIG. 1, a 5G, 6G or other RAN-type core network 142 can be implemented using cloud-based computing resources, such as those available from Amazon Web Services Inc. (AWS) of Seattle, Washington. Other cloud services are available from Microsoft Corp. of Redmond, Washington, IBM Corp. of Armonk, New York, and others. In the example illustrated in FIG. 1, common services (e.g., billing, guest network allocation, etc.) can be performed in a shared service implemented within a common virtual private cloud (VPC) operating within the cloud environment 142. As noted above, each of the various components of core network 142 are typically implemented using software or firmware instructions that are stored in a non-transitory data storage (e.g., a disk drive or solid state memory) for execution by one or more processors within the VPC. VPCs may provide any number of additional features to support the data handling functions of the system, including redundancy, scalability, backup, key management and/or the like using any number of computing planes that are implemented in any manner. As noted above, some embodiments may further abstract the hardware used to implement components of network 100 by using Kubernetes or similar container structures, as desired.

The particular arrangement of RUs 111-118, DUs 133-139 and CU 132 set forth herein is intended to illustrate certain concepts, but practical implementations may use any numbers of RUs, DUs and CUs that are geographically or logically distributed and inter-connected in any manner desired. As noted above, it is generally necessary to distribute and deploy an appropriate number of RUs 111-118 within broadcast range of end users to cover a desired geographic region of network 100. But by implementing the other functions of the network using a data center 120 and/or virtualized hardware operating within a cloud-type architecture, geographic restrictions upon the network 100 can be greatly reduced. This can provide substantial efficiencies in deployment and expansion of network 100, while also allowing for more efficient use of computing resources, data storage and electric power.

RUs 111-116 operating at so-called “dark” sites may be paired or otherwise connected with DUs 133-138 operating within a BEDC 120 and/or cloud network 142 in any manner. In the examples illustrated in FIG. 1, computing logic 144 or 145 present within core network 142 or BEDC 120 (respectively) suitably assigns RUs 111-116 to available DUs according to the concepts forth herein. Initial assignment may take place when one or more RUs 111-116 power up or otherwise come online, and assignment may be re-assessed at any time to permit adaptation to outages, changing network conditions, additional RUs coming online, and/or any other factors as appropriate.

FIG. 1 shows control logic 144, 145 maintaining a data table 150 to represent mappings of RUs to DUs, as desired. In the example of FIG. 1, RUs are associated with group identifiers based upon any desired affinity relationships that may be desired. Note that “affinity” relationships as referenced herein could include both a desire to maintain the RUs within the same group, as well as a desire to maintain the RUs in separate groups. The term “affinity grouping”, then, is intended to collectively refer to both “affinity” and “anti-affinity” grouping, unless another meaning is clear from context. RUs may be therefore grouped in any manner so that certain RUs are maintained within the same group, or so that certain RUs are kept in separate groups.

In the example of FIG. 1, table 150 maintains data fields for geographic affinity as well as spectrum affinity. Geographic affinity may refer to DUs that are located in close physical proximity to each other, for example, so that their broadcast ranges overlap, or at least come very close to each other. In some embodiments, it may be desirable to support geographically close RUs with DUs operating on different servers so that a DU server outage has a lesser impact upon service in a particular area. That is, it may be desirable to spread the effects of a DU rack or server outage across a wider geographic area, recognizing that other RUs connected to still-operating DUs may be able to pick up some or all of the traffic that would otherwise go to the isolated RU. Conversely, there may be a desire in some situations to place geographically-close RUs on the same server or rack to confine the effects of a DU outage to a relatively small geographic area. Note that different geographic affinity (or anti-affinity) considerations could drive a decision to reassign RUs at different times. Heavily used or centrally-located RUs could be re-located from a server or rack that is about to undergo maintenance, for example, while lesser-used RUs are assigned to the DU while it is operating at reduced capacity (or even shut down). Other considerations could drive RU-DU assignments under different times and conditions, as appropriate.

The example table 150 illustrated in FIG. 1 also includes a data field representing spectrum affinity, which may or may not be relevant in any particular implementation. If desired, RUs 111-118 that use the same (or similar, e.g., overlapping) spectrum can be assigned with regard to affinity (or anti-affinity) for that spectrum. If a particular portion of the spectrum is reserved for a network associated with a particular customer, for example, it may be desirable to place those RUs on a shared rack or server that is maintained by (or at least associated with) that customer. Similarly, even though DUs typically deal with digital representations of the spectrum rather than propagating radio waves, it may be desirable to separate overlapping spectrum across different racks or servers for further isolation, and to prevent any sort of cross-talk that could otherwise occur. Spectrum affinity could be further used to reinforce geographic anti-affinity, if desired (e.g., so that spectrum overlap is associated with lack of geographic overlap), although other embodiments could treat spectrum affinity in other ways. Still other embodiments may not consider spectrum affinity at all in assigning RUs to DUs if interference is not a concern.

In the example of table 150 that is illustrated in FIG. 1, geographic and spectrum affinity (or anti-affinity) is managed by assigning each RU to a group that is indicated with a letter or other identifier. “Groups” in this example could represent either affinity or anti-affinity. That is, RUs in geographic group “A” could be considered to have affinity (e.g., desire to keep them together), or anti-affinity (e.g., desire to separate them), as desired. Further embodiments could consider both affinity and anti-affinity groups if it is desired to group certain RUs together while separating other RUs. This could be achieved by adding additional fields to table 150, if desired, or by assigning RUs to groups with consideration to both affinity and anti-affinity. Similarly, spectrum groups could be assigned with regard to affinity and/or anti-affinity groups. The example group identifiers presented in table 150 are only for purposes of illustration, and practical embodiments will generally have different grouping according the needs of that implementation.

RUs 111-116 may be assigned to DUs 133-138 residing within a pool of available DU modules in any manner. Control logic 144, 145 may manage RU-to-DU assignments using the processes set forth below, for example. Control logic 144, 145 may additionally manage the activation and/or deactivation of DUs 133-138 using, for example, Kubernetes control concepts that spawn or de-spawn worker nodes implementing the various DUs, as appropriate. Other embodiments could handle the activation of DU modules 133-138 separately from the assignment of RUs to DUs, and/or may operate in any other manner.

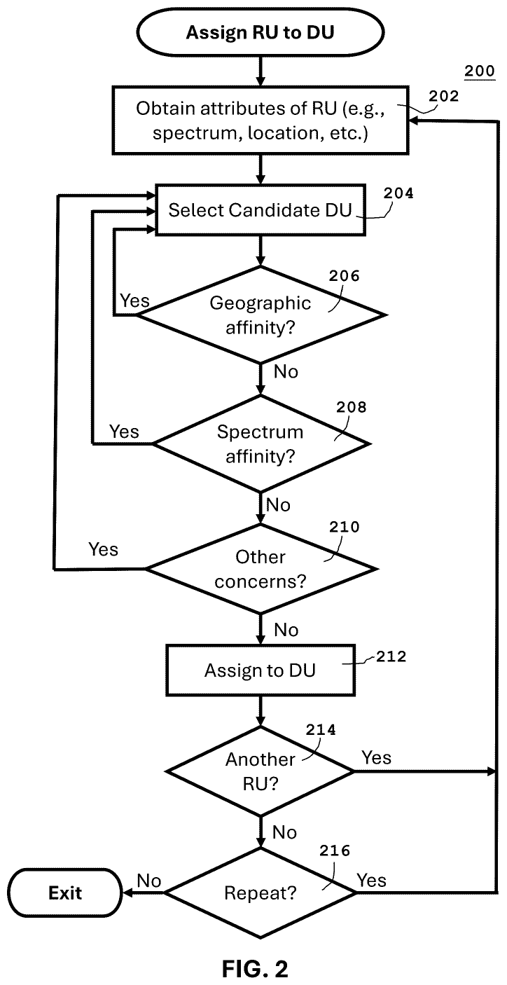

One example of an automated process 200 for assigning Open RAN RUs 111-116 to DUs 133-138 is illustrated in FIG. 2. Such a process 200 may be executed by hardware, software and/or firmware logic within control logic 144, 145 or elsewhere, as desired.

With reference now to FIG. 2, an example process 200 suitably includes the broad functions of obtaining information about one or more RUs 111-116 (function 202), processing any number of geographic affinity, spectrum affinity and/or other rules (functions 206, 208, 210), and assigning the CU under evaluation to a DU that fits the various criteria (function 212). The process 200 may be repeated as needed to assign any number of RUs (function 214), and/or to reassign RUs at a later date or time (function 216). The various functions shown in FIG. 2 may be enhanced, modified and/or distributed amongst the various physical and/or virtual computing components of network 100 in any manner, and different embodiments may organize the processing of various features in any number of different ways.

The example flowchart illustrated in FIG. 2 is intended to convey the general concepts of RU-DU assignment, but it may not literally describe be the most computationally efficient manner to assign RUs to DUs in practice. Practical embodiments may use more sophisticated data structures and algorithms such as linear probing or the like, in which a hash table or similar structure representing available DUs is traversed in a linear fashion for each RU until an appropriate DU is identified. Other embodiments could use equivalent data structures and processing routines to perform the basic functions that are described herein.

Information about each RU 111-116 awaiting assignment may be obtained in any manner. In various embodiments, the RU information is stored in a database or similar structure 150 that is available to processing logic 144, 145. Table 150 may be populated in any manner. In some implementations, manual data entry may be necessary for some basic information (e.g., presence of an RU at a particular latitude/longitude or other geographic location, assigned spectrum, etc.), but additional information may be automatically populated into table 150 based upon information known about the RU, information about other RUs located in the vicinity, assigned spectrum and the like. Such information may be available from data sources in core network 142, information about the RU hardware, geographic or mapping information, and/or other data sources as desired.

As noted above, RUs may be assigned to DUs based upon any desired parameters. In the example of FIG. 2, RUs are assigned using concepts of geographic affinity (including anti-affinity, if desired) and spectrum affinity (or anti-infinity, if desired). In the process 200 shown in FIG. 2, processing logic 144, 145 evaluates each RU 111-116 by selecting a candidate DU from the pool of DUs 133-138, etc. that are available. The candidate DU is evaluated to determine if affinity constraints for the RU are maintained (functions 206, 208). If the DU is located on a server or rack that already handles RUs within the same geographic affinity group as the candidate RU, for example, it may be desirable to reject the candidate DU (“yes” path from function 206 in FIG. 2) and consider a different candidate DU (function 204). Equivalent embodiments could treat an anti-affinity desire the same way; if the candidate DU does not meet the constraints imposed, then it is rejected in favor of a different DU. Both affinity and anti-affinity could be managed by, for example, repeating function 206 to manage multiple data fields in table 150 (e.g., one field for affinity, another for anti-affinity) if desired. Other embodiments could implement multi-factor processing in any other manner.

The candidate DU can be similarly evaluated based upon spectrum affinity (function 208), and/or any other factors (function 210) if desired. If assignment to the candidate DU would violate any constraints imposed, then the candidate DU is rejected and another DU is considered. This process continues until a candidate DU is found that does not violate any of the constraints imposed. The identified DU is then associated with the RU (function 212), and processing continues for another RU, if desired (function 214). Assignment of the RU to the selected DU may involve any number of actions. Typically, data table 150 will be updated to reflect the new assignment, and the DU and RU will be notified to begin front haul connections using any appropriate protocols.

Process 200 may be executed on any temporal basis and may be repeated as needed (function 216). In various embodiments, process 200 is executed in response to a new DU coming online so that an appropriate DU can be quickly identified. Process 200 could similarly be initiated by a DU when a connection to an RU is lost, or by an RU for similar reasons. Changing network conditions (e.g., adding or removing RUs, fluctuations in network traffic, and/or any other factors) could initiate DU assignment (or reassignment), if desired. In still further embodiments, it may be desirable to reassign RUs to different DUs for purposes related to load balancing, minimizing the effects of outages (e.g., outages due to computing, communications or power failure), reducing the effects of maintenance, isolating components associated with a particular customer network, and/or any other factors as desired. Still other embodiments could re-purpose or shut down certain RUs and/or DUs at night, or during other periods of time that traffic is lighter, thereby initiating re-assignment of RU-DU relationships as appropriate. In this example, affinity rules may become helpful in identifying redundant components that could be shut down without dramatically affecting the service provided by network 100.

Various systems, automated processes and computing devices have therefore been described for automatically assigning radio units (RUs) to distributed units (DUs) in an Open RAN network. Automatic assignment can consider geographic affinity, if desired, and/or any additional factors as appropriate.

The general concepts set forth herein may be adapted to any number of alternate but equivalent embodiments. The term “exemplary” is used herein to represent one example, instance or illustration that may have any number of alternates. Any implementation described herein as “exemplary” is not necessarily to be construed as preferred or advantageous over other implementations, nor is it necessarily intended as a model that must be duplicated in other implementations. While several exemplary embodiments have been presented in the foregoing detailed description, it should be appreciated that a vast number of alternate but equivalent variations exist, and the examples presented herein are not intended to limit the scope, applicability, or configuration of the invention in any way. To the contrary, various changes may be made in the function and arrangement of elements described without departing from the scope of the claims and their legal equivalents.

What is claimed is:

1. A wireless network system comprising:
a plurality of Open Radio Access Network (RAN) radio units (RUs), each of the plurality of RUs each having an associated geographic location;
a pool of RAN distributed units (DUs) associated with a data processing system, the data processing system comprising a plurality of DU processors each executing one or more of the pool of RAN DUS; and
a controller associated with the data processing system, wherein the controller is configured to automatically assign each of the plurality of RUs to one of the DU processors available in the pool based upon the geographic location associated with the RU to thereby prevent RUs in geographical proximity to each other from being assigned to the same DU processor.

2. The wireless network system of claim 1 wherein the data processing system implements the pool of RAN DUs with an array of rack-mounted computer systems each having at least one of plurality of DU processors.

3. The wireless network system of claim 1 wherein the data processing system implements the pool of RAN DUs within the processing cloud, and wherein each of the plurality of DU processors executes using virtual processing resources of a processing cloud.

4. The wireless network system of claim 1 wherein the controller automatically assigns each of the plurality of RUs to the DU processors available by applying one or more affinity rules relating to the geographic proximities of the RUs associated with the DU processor.

5. The wireless network system of claim 4 wherein each of the plurality of RUs is associated with a radio frequency (RF) spectrum, and wherein the affinity rules further prohibit RUs having overlapping RF spectrum from being assigned to the same DU processor.

6. The wireless network system of claim 1 wherein each of the plurality of RUs is associated with a radio frequency (RF) spectrum, and wherein the controller is configured to prohibit RUs having overlapping RF spectrum from being assigned to the same DU processor.

7. The wireless network system of claim 1 wherein controller is configured to maintain a table that maps each of the RUs to its associated DU processor in the pool.

8. The wireless network system of claim 1 wherein controller is further configured to update the table and to reassign at least some of the RUs to other DU processors based upon changes to the wireless network.

9. The wireless network system of claim 1 wherein the processor is configured to repeat the automatic assigning of plurality of DUs within the pool as network conditions change to accommodate fluctuations in network traffic.

10. A computing system for implementing a pool of Open Radio Access Network (RAN) distributed units (DUs), the computing system comprising:
a plurality of DU processors each configured to perform the functions of one or more of the RAN DUs in the pool of RAN DUS; and
a controller associated with the computing system, wherein the controller is configured to automatically assign each of a plurality of RAN radio units (RUs) to one of the DU processors based upon a geographic location associated with the RU to thereby prevent RUs in geographical proximity to each other from being assigned to the same DU processor in the pool of DU processors.

11. The computing system of claim 10 wherein the plurality of DU processors comprises an array of rack-mounted computer systems.

12. The computing system of claim 10 wherein the plurality of DU processors implements the pool of RAN DUs using virtual processing resources of a processing cloud.

13. The computing system of claim 10 wherein the controller automatically assigns each of the plurality of RUs to one of the DU processors available in the pool of RAN DUs by applying one or more affinity rules relating to the geographic proximities of the RUs associated with the DU processor.

14. The computing system of claim 12 wherein the plurality of RAN DU processors is implemented using virtual private cloud (VPC) resources of the processing cloud.

15. The computing system of claim 12 wherein the plurality of RAN DU processors is implemented using worker node structures implemented within a Kubernetes container system.

16. An automated process performed by a computer system to automatically assign each of a plurality of Open Radio Access Network (RAN) radio units (RUs) to available RAN distributed units (DUs) within a pool of DU processors, the automated process comprising:
obtaining, by the computer system, a geographic attribute of each RU;
determining, by the computer system for each of a plurality of candidate DUs within the pool of DU processors based upon the geographic attribute of the RU, whether the RU is in geographical proximity to other RUs assigned to the same DU processor; and
assigning the RU to the same DU processor if the geographical proximity to other RUs complies with a geographic affinity rule, and otherwise evaluating another of the plurality of candidate DUs.

17. The automated process of claim 16 wherein the geographic affinity rule requires geographic affinity between the RUs assigned to the same DU processor so that RUs in geographical proximity to each other are assigned to the same DU processor.

18. The automated process of claim 16 wherein the geographic affinity rule requires geographic anti-affinity between the RUs assigned to the same DU processor so that RUs in geographical proximity to each other are assigned to different DU processors.

19. The automated process of claim 16 wherein each of the plurality of RUs is associated with a radio frequency (RF) spectrum, and wherein the automated process further comprises prohibiting RUs having overlapping RF spectrum from being assigned to the same DU processor.

20. The automated process of claim 16 wherein the computer system is a cloud-based computing system, and wherein each of the plurality of DU processors is implemented using a container of the cloud-based computing system.
